(19) United States
(12) Patent Application Publication
(10) Pub. No.: US 2015/0165912 A1
(43) Pub. Date: Jun. 18, 2015

(54) Wind turbine in car that powers a battery with the help of a generator

(71) Applicant: Marie Mahruk Patel, Bethpage, NY (US)

(72) Inventor: Marie Mahruk Patel, Bethpage, NY (US)

(21) Appl. No.: 13/998,827

(22) Filed: Dec. 12, 2013

(51) Int. Cl. B60L 8/00

(52) U.S. Cl. CPC B60L 8/006

(57) ABSTRACT

The invention pertains to the use of existing machinery in a new setting or venue. Wind power rotates a turbine in the car which runs a generator with or without the help of a gear box. The generator produces a current which is stored in a battery. The battery powers the car. The battery keeps getting charged while the car is moving. The supplementary battery charge eliminates the use of a gasoline engine in the car.

### CROSS REFERENCE

Not applicable

### BACKGROUND

The field of endeavor is an electric car or vehicle

### BRIEF SUMMARY

The use of a wind turbine to power a battery with the help of a generator.

### DRAWING

I have shown the different machinery used for my invention. The machinery already Exist and have already been invented. I am just putting the machinery together and Placing them in a new setting i.e. a vehicle. The machinery is not shown in detail as a Result. The different machinery used is as follows:

FIG. 1 a. a kind of wind turbine which is suitable for the invention
b. If needed a kind of gearbox as suited for the invention.
c. Generator (ac or dc generator) as suitable for the invention
d. With or without inverter. Inverter will be required if ac generator is used.
e. Battery packs which are powered by the generator and also powered by plugging into an electrical outlet.
   All these individual machinery will be placed in a vehicle to provide additional mileage for the Vehicle, by charging the battery in the vehicle while it is moving.

FIG. 2 of drawing is provided without any markings as required by your letter.

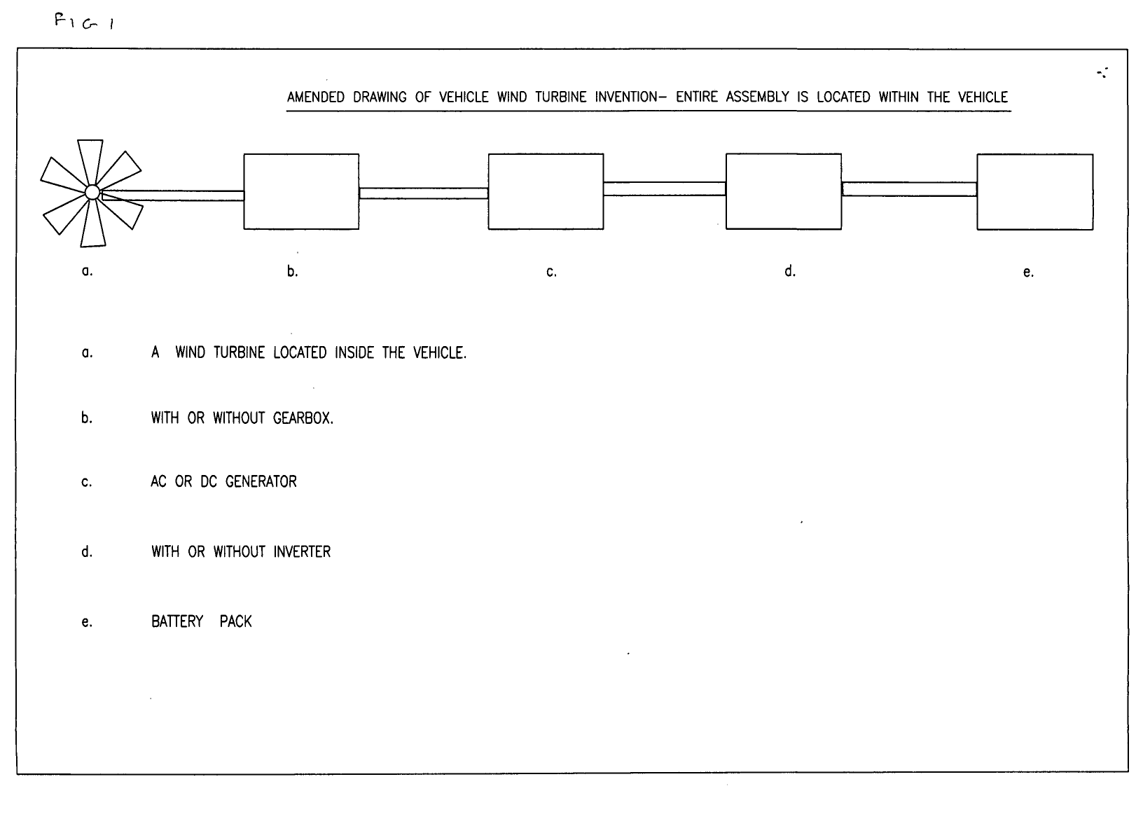

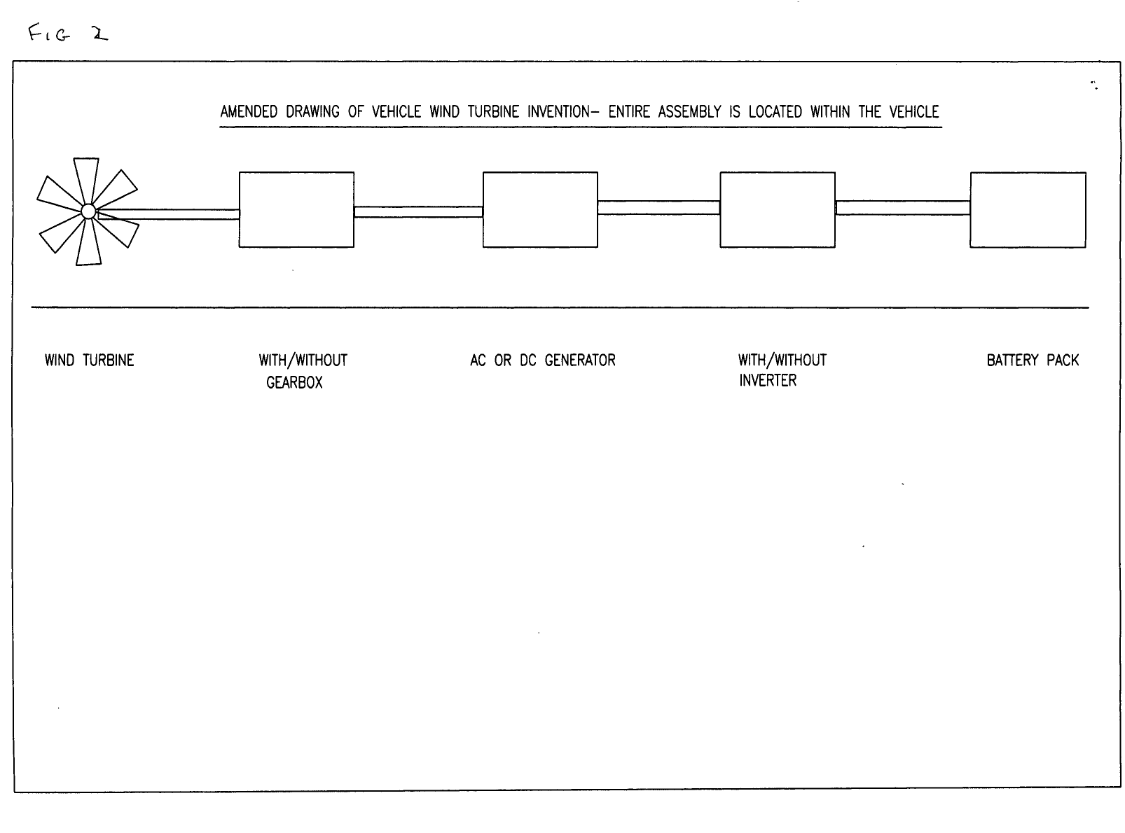

### DETAILED DESCRIPTION

I have put together several existing mechanical/electrical components within a new Setting i.e. a vehicle. Each component by itself is not new, but the combination in which it Is proposed to be used within a vehicle is a novel idea.

The invention consists of a wind turbine (any kind), which is placed in an optimum location In the car or vehicle. While the vehicle is moving, air blows over the turbine through an Opening in the car and makes the turbine rotate. The mechanical energy of the turbine Passes to a gear box (which may be needed to increase the speed of the rotation of the generator.) From the gear box the mechanical energy then passes to a generator.

The generator produces a current. Depending upon which kind of generator is used (AC or DC) you get an ac or dc current. If DC generator is used, the dc current produced is Stored directly in the battery of the vehicle. If AC generator is used, the AC current is made to Pass through an inverter, which converts ac to dc current which is then stored in the battery.

While the car is running, the turbine blades turn with the help of wind power and keep Charging the battery, which in turn powers the car. The battery can also be charged by Plugging into an electrical current. Thus there are two ways of charging the battery. The battery is charged from an electrical outlet, and then while the car is running, the Battery gets supplemental power from wind that turns a turbine and generator.

1. The use of gasoline engine in a car or vehicle is eliminated, As the car runs on battery power. While the car is running, The wind energy rotates a turbine which is hooked up to a generator with or without the help of a gear box. The generator produces a current which is stored in the battery which powers the car. The battery is also charged by plugging into an electrical outlet.
